(19) United States
(12) Patent Application Publication
(10) Pub. No.: US 2003/0053672 A1
(43) Pub. Date: Mar. 20, 2003

(54) Method and X-ray device for enhancing the quality of a radiographic image

(76) Inventor: Steven Lobregt, Eindhoven (NL)

Correspondence Address: EUGENE E. CLAIR, Philips Medical Systems (Cleveland), Inc., 595 Miner Road, Cleveland, OH, 44143, US

(21) Appl. No.: 10/230,036

(22) Filed: Aug. 28, 2002

(30) Foreign Application Priority Data
Aug. 29, 2001 (EP) 01203256.1

(51) Int. Cl. G06K 9/00; G06K 9/40

(52) U.S. Cl. 382/132; 382/254

(57) ABSTRACT

The invention concerns a method of enhancing the quality of a radiographic image for medical purposes. Thereto at least one not relevant image area is defined in said radiographic image in which the image points are assigned different values such that a pattern is formed for masking off said image area. As an alternative or in combination therewith, the image points in the not relevant image area are assigned color values.

An X-ray device for medical examination is described, comprising an X-ray source 1 emitting a beam of X-rays 2 towards an object 3 to be examined, an X-ray detector 4 for receiving the X-rays passed through the object and image processing means 10, which are connected to the X-ray detector, for forming an image of said object. The image processing means are arranged to carry out the steps of the method according to the invention. Furthermore a computer program is described to carry out the method according to the invention.

### BACKGROUND

The present invention relates to a method and apparatus for enhancing the quality of a radiographic image for medical purposes, which radiographic image is represented by image points.

A method is known from European patent EP 0 523 771 which concerns masking off not relevant parts of a radiographic image. Radiographic images usually contain image areas, which are of less or no interest from a medical point of view. Some examples of non interesting image areas are image areas that are related to the shape of the exposed field or image areas that are covered by absorption means, which are placed between the X-ray source and an object to be examined, usually a human patient, for narrowing the X-ray beam.

A radiographic image is usually processed to enhance the quality thereof, after which it is visualized on a display screen and/or copied onto a suitable medium, such as film, for diagnostic evaluation. When, by way of example, the non-interesting image areas are the image areas that were covered by absorption means during exposure to X-rays, these areas present themselves as areas of high brightness in the images. It is a known effect in the medical field that these bright non-interesting image areas surrounding the medical relevant image areas hamper the diagnostic evaluation of the latter. Two effects contribute to these sub-optimal evaluation conditions in the above described and other similar situations. Firstly, the human eye is sensitive to the bright image areas, which causes sub-optimal contrast perception in the darker areas, which are in this case the relevant parts of the image. Secondly, display and printing software and hardware use a limited range of grey values for actual rendering of image values. Non-relevant image areas may consume a part of this available range of grey values, thus reducing the range of grey values which remains available for the relevant parts of an image, with the effect that those relevant image parts are displayed or printed with sub-optimal contrast.

According to the known method this problem is solved by assigning grey values to the image points in the not relevant image area for masking off said image points. The assigned values are preferably uniform and are expressed in relation to film density values in a specific range from 0.5 to 2.5.

The known method has the disadvantage that it is not immediately apparent which parts of the thus processed radiographic image comprise the anatomic information, since now both interesting and non interesting image areas are represented by grey values in the same range.

### SUMMARY OF THE INVENTION

It is an object of the method according to the invention to present a method according to the preamble, which overcomes this disadvantage of the state of the art while maintaining the advantages thereof.

These objects are achieved by the first method according to the invention, which is characterized in that the image points in the not relevant area of the radiographic image are assigned different values such that a pattern is formed.

These objects are also achieved by the second method according to the invention, which is characterized in that the image points in the not relevant area of the radiographic image are assigned color values.

Both methods according to the invention and all conceivable combinations thereof allow for an immediate distinction to be made between the interesting and the non-interesting image areas processed by the method. Thus processed radiographic images can now be transferred to other medical personnel, e.g. as part of a medical report, f.i. as a computer file or on film, without the need for additional information identifying the non-interesting image areas processed by the method. This way storage space is effectively saved. Radiographic images processed by means of the method according to the invention can also be easily processed further, while restricting the processing to the interesting image areas. This way computer time is effectively saved.

In the following a number of sub claims are described which relate to the first and/or second embodiment as well as to the combination thereof.

In a preferred embodiment of the method according to the invention neighboring image points or groups of neighboring image points are assigned alternating values. Thus a checkerboard pattern is created. Because of the high resolution provided for by present-day print film as well as screen displays, the spatial frequency of such a pattern can be very high, which allows for a non-disturbing perception by the viewer, resembling an area of constant grey value, while maintaining the information necessary to distinguish the interesting and non-interesting image areas.

According to another preferred embodiment of the method according to the invention a color with a low saturation value is used to mask the non-interesting image areas, again leading to an impression of constant grey value for the human eye, while maintaining the information necessary to distinguish the interesting and non-interesting image areas.

In yet another preferred embodiment of the method the image points in the not relevant area of the radiographic image are merged with values having a predetermined grey value or color value and a predetermined degree of opacity. If the grey values which are merged with the original image values have a high enough degree of opacity, f.i. 75% or more, the areas are perceived as having an almost constant grey value. This presents an alternative way to achieve the masking off of the non-interesting image areas while preserving the original image information thereof.

Now the not relevant image areas are made distinguishable from the relevant image areas according to the method of the invention computer time can effectively be saved in a further preferred embodiment by applying one or more image processing techniques only on the latter. Advantageously the full range of visualization values remains available for the relevant parts of an image, allowing those relevant image parts to be displayed or printed with optimal contrast.

Storage space can be saved by automatically removing one or more of the not relevant image areas from the radiographic image according to another preferred embodiment of the method according to the invention.

For printing the radiographic image on a film the assigned values are converted to values lying in a predetermined film density range, which is preferably a range of 0-0.49 and/or 2.51-3.0.

The invention also refers to an X-ray device for medical examination comprising an X-ray source emitting a beam of X-rays towards an object to be examined, an X-ray detector for receiving the X-rays passed through the object and image processing means, which are connected to the X-ray detector, for forming an image of said object, wherein the image processing means are arranged to carry out the steps of the method according to the invention.

The invention further concerns a computer program to carry out the method according to the invention.

The following description, claims and accompanying drawings set forth certain illustrative embodiments applying various principles of the present invention. It is to be appreciated that different embodiments applying principles of the invention may take form in various components, steps and arrangements of components and steps. These described embodiments being indicative of but a few of the various ways in which some or all of the principles of the invention may be employed in a method or apparatus. The drawings are only for the purpose of illustrating an embodiment of an apparatus and method applying principles of the present invention and are not to be construed as limiting the present invention.

### BRIEF DESCRIPTION OF THE DRAWINGS

The foregoing and other features and advantages of the present invention will become apparent to those skilled in the art to which the present invention relates upon consideration of the following detailed description of apparatus applying aspects of the present invention with reference to the accompanying drawings, wherein:

FIG. 1 schematically shows a preferred embodiment of an X-ray examination apparatus according to the invention; and

FIGS. 2A and 2B show non-interesting image areas of a radiographic image that are represented by image points to which different values are assigned such that a pattern is formed.

### DETAILED DESCRIPTION

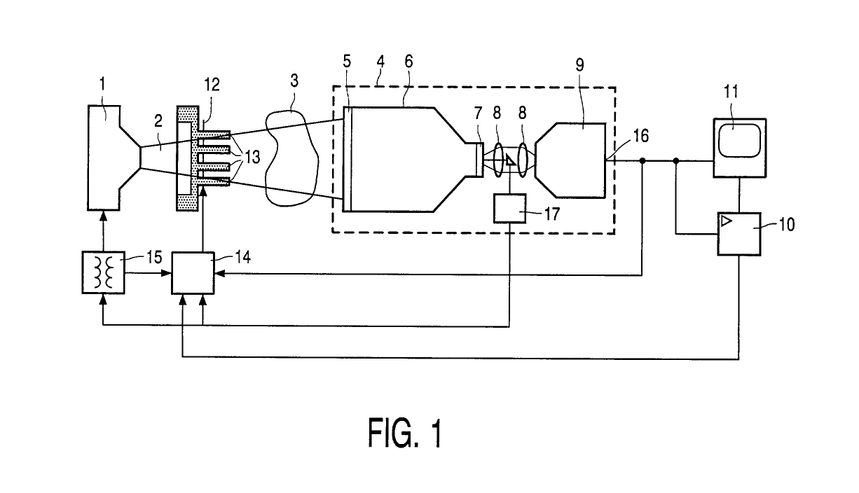

FIG. 1 shows an X-ray examination apparatus in accordance with the invention. The X-ray source 1 emits an X-ray beam 2 whereto an object 3, for example a patient to be examined, is exposed. As a result of local differences in the absorption of X-rays in the object 3 an X-ray image is formed on the X-ray detector 4, which is in this case an image intensifier pick-up chain. The X-ray image is formed on the entrance screen 5 of the X-ray intensifier 6 and is converted into a light image an the exit window 7, which light image is imaged on a video camera 9 by means of a lens system 8. The video camera 9 forms an electronic image signal from the light image. The electronic image signal is applied to an image-processing unit 10 for further processing. The radiographic image is also applied to the monitor of graphics device 11 on which the image information in the X-ray image is displayed.

Between the X-ray source 1 and the object 3 there is arranged the filter 12 for local attenuation of the X-ray beam 2. By way of example only in the embodiment shown filter 12 comprises various filter elements 13 in the form of capillary tubes whose X-ray absorptivity can be adjusted by application of electric voltages to the inner side of the capillary tubes by means of an adjusting circuit 14. The adjusting circuit receives input from the image processing unit 10, an exposure control system 17 and the power supply 15 of the X-ray source 1. It is noted that filter 12 can be replaced by any kind of suitable filter, as the choice of filter is off course irrelevant for the present invention, as will be clearly understood by any person skilled in the art.

The X-ray device according to the invention, and more specifically the image processing unit 10 thereof, is arranged for carrying out the steps of the method according to the invention which are now in more detail described.

Step 1: Selecting at Least One not Relevant Image Area

This selection can be performed automatically as well as manually. Preferably the radiographic image is visualized on the display screen 11. The user, usually a medically skilled person, can f.i. manually define an area of interest on that screen by means of a pointer device, such as a mouse or a keyboard, or by means of his or her fingers when the display screen is a so-called touch screen. An example of a method of automatically defining a not relevant image area in a radiographic image is described in the patent application EP 0 635 804 of the same applicant. This patent pertains to the automatic detection of the shape and location of image areas, which are covered by absorption filters.

Step 2: Masking Off Said not Relevant Image Area

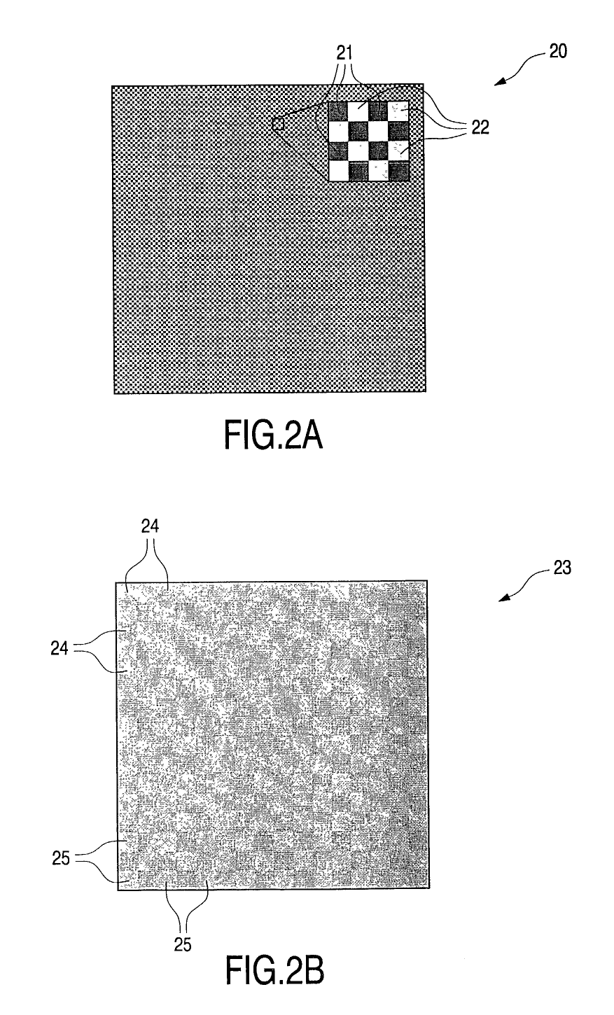

This step can be performed by means of the first and second method according to the invention and all combinations thereof. The first method according to the invention is illustrated by FIGS. 2A and 2B, that each show an image area, respectively 20 and 23, defined as “not relevant or non-interesting”, as part of a radiographic image (not shown) recorded by means of the X-ray examination device of FIG. 1. The image is displayed on display screen 11 on which the image points are represented by picture elements (“pixels”), which are assigned different values such that a pattern is formed. In the examples shown groups of neighboring pixels in row and column direction are assigned alternating values. In the examples shown only two separate values are used, resulting in a checker board pattern. The difference between these values can be varied from 1 step in grey value up to as many steps as desired. The group size can also be varied as desired. In FIG. 2A a groups 21, 22, each comprising 2 pixels, are shown with a difference in grey values of 100 steps on an available range of 256 steps. In FIG. 2B groups 24, 25, each comprising 16 pixels, are shown with a difference in grey value of 8 steps on an available range of 256 steps. The combination of group size and difference in applied grey values determines the visibility of the pattern for the human eye. A visible pattern has the advantage that it is immediately recognizable as such by the user, which will facilitate the diagnostic evaluation.

The radiographic image can also be processed for printing on film. Several techniques are known in the relevant field to accomplish this. Usually an internal range of pixel values is defined during image processing, for example 0-300. It is noted that the definition of the internal range is a matter of choice and many other suitable ranges could be defined. In practice a processed image can be printed on many different commercially available films with varying film density ranges. One example is a film density range between 0 and 3.2 as mentioned in the state of the art. Before printing a calibration step is performed in which the internal range is converted to the range available for printing the image on film, which range also depends on the film printer used.

When defining a pattern the visibility thereof is determined by the group size and by the values to be assigned to the different image points. When a relatively small group size is used the image area with pattern appears to the human eye as an image area of nearly constant grey value, like the one shown in FIG. 2a. Generally, the larger the group size is, the more clearly the pattern becomes visible. The contrast between the different groups can be set by choosing the difference between the values assigned. For creating a clearly visible pattern alternating values are preferably chosen from the internal range of 0-49 and 251-300. For printing the results on a film these values are to be converted to corresponding film density ranges of for instance 0-0.49 and 2.51-3.2.

It will be apparent to any skilled person that more than two different values can be used and assigned to different groups thus creating a more complex pattern.

An alternative is presented by the second method according to the invention. The pixels are assigned alternating values of a certain color. In order to maintain an image that is calm for the eye preferably a color with a low saturation value is chosen, such as 20% or lower. The user will perceive this color as grey. In order to allow for a more clearly visible distinction of the relevant and not relevant image areas a saturation value higher than 20% should be chosen. Such a clear distinction between the different areas is immediately recognizable as such by the user, which will facilitate the diagnostic evaluation. As the use of color can only be seen on a color screen or color print the results of the second method are not shown here.

According to the first and second method described above and the combination the image points in the not relevant area of the radiographic image are assigned new values. As an alternative the original values of said image points could be merged with values having a predetermined degree of opacity. As an example 75% opacity can be used, meaning that each image point in the not relevant image area is assigned a value made up of 25% of the originally recorded value thereof and 75% of a new value. The new values can either be grey values or color values and are defined as a so-called mask having a predetermined shape corresponding to the shape of the not relevant image area in question.

The invention is of course not limited to the described or shown embodiments, but also relates to all conceivable combinations thereof. For example according to the first method a pattern can be defined as being formed by image points which can be assigned color values or a combination of color and grey values, for instance alternating color and grey values.

The method according to the invention is to be carried out by an X-ray examination device for medical purposes, such as the device shown in FIG. 1. Now the method of the invention is explained a person skilled in the art will be able to arrange the image processing means thereof such that they can carry out the steps of the method. Preferably these method steps are carried out by a computer program. Using the teaching of this patent application in combination with the knowledge available in the field a skilled person will be able to translate the steps of the method into such a computer program to carry out the method.

The methods according to the invention generally teach how to allow for an unambiguous distinction to be made between the relevant and not relevant image areas of a radiographic image. Thereto the image points in the not relevant image areas are assigned new values. Depending on the details of the embodiment chosen the resulting not relevant image areas may either be visually distinguishable for a human eye or not. In both cases the resulting not relevant image areas are always distinguishable by means of digital processing techniques carried out on a computer. This allows the computer to concentrate all image-processing techniques to enhance the quality of the image only on the relevant image areas thus saving computer time. Furthermore, non-interesting areas can be automatically removed from the image. The thus processed radiographic image only comprises the relevant image areas, storage space is effectively saved. As an alternative the radiographic image can be stored without the not relevant image areas on the borders thereof. This way advantageously a lot of storage space is saved on the storage medium, such as film, hard disk, floppy disk, cd etc.

The invention is of course not limited to the described or shown embodiments, but generally extends to any embodiment, which falls within the scope of the appended claims as seen in light of the foregoing description and drawings. While a particular feature of the invention may have been described above with respect to only one of the illustrated embodiments, such features may be combined with one or more other features of other embodiments, as may be desired and advantageous for any given particular application. From the above description of the invention, those skilled in the art will perceive improvements, changes and modification. Such improvements, changes and modification within the skill of the art are intended to be covered by the appended claims.

Having described a preferred embodiment of the invention, the following is claimed:

1. A method of enhancing the quality of a radiographic image for medical purposes, which radiographic image is represented by image points, said method comprising the steps of:
defining at least one not relevant image area; and
assigning values to the image points in the not relevant image area for masking off said image area, characterized in that, the image points in the not relevant area of the radiographic image are assigned different values such that a pattern is formed.

2. A method according to claim 1, wherein neighboring image points are assigned alternating values.

3. A method according to claim 1, wherein neighboring groups of image points are assigned alternating values.

4. A method of enhancing the quality of a recorded radiographic image for medical purposes, which radiographic image is represented by image points, said method comprising the steps of:
defining at least one not relevant image area; and
assigning values to the image points in the not relevant image area for masking off said image points, characterized in that, the image points in the not relevant area of the radiographic image are assigned color values.

5. A method according to claim wherein the image points in the not relevant area of the radiographic image are assigned color values.

6. A method according to claim 4 wherein the color has a low saturation value.

7. A method according to claim 1 wherein the image points in the not relevant area of the radiographic image are merged with values having a predetermined grey value or color value and a predetermined degree of opacity.

8. A method according to claim 1 including the step of applying one or more image processing techniques only on the relevant image areas.

9. A method according to claim 1 including the step of automatically removing one or more of the not relevant image areas from the radiographic image.

10. A method according to claim 1 wherein the assigned values are converted to values lying in a predetermined film density range for printing the radiographic image on a film.

11. A method according to claim 10, wherein the film density range is 0-0.49 and/or 2.51-3.2.

12. An X-ray device for medical examination comprising:
an X-ray source emitting a beam of X-rays towards an object to be examined;
an X-ray detector for receiving the X-rays passed through the object; and
image processing means connected to the X-ray detector, the image processing means for forming an image of said object, the image processing means including;
means for defining at least one not relevant image area; and
means for assigning values to the image points in the not relevant image area for masking off said image points, characterized in that, the image points in the not relevant area of the radiographic image are assigned color values.

13. An X-ray device for medical examination comprising:
an X-ray source emitting a beam of X-rays towards an object to be examined;
an X-ray detector for receiving the X-rays passed through the object; and
image processing means connected to the X-ray detector, the image processing means for forming an image of said object, the image processing means including;
means for defining at least one not relevant image area; and
means for assigning values to the image points in the not relevant image area for masking off said image points, characterized in that, the image points in the not relevant area of the radiographic image are assigned color values.

14. A method according to claim 4 wherein the image points in the not relevant area of the radiographic image are merged with values having a predetermined grey value or color value and a predetermined degree of opacity.

15. A method according to claim 4 including the step of applying one or more image processing techniques only on the relevant image areas.

16. A method according to claim 4 including the step of automatically removing one or more of the not relevant image areas from the radiographic image.

17. A method according to claim 4 wherein the assigned values are converted to values lying in a predetermined film density range for printing the radiographic image on a film.
